(19) United States
(12) Patent Application Publication
(10) Pub. No.: US 2007/0280309 A1
(43) Pub. Date: Dec. 6, 2007

(54) Optical waveguide with single sided coplanar contact optical phase modulator

(76) Inventor: Ansheng Liu, Cupertino, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/439,769

(22) Filed: May 23, 2006

(51) Int. Cl. H01S 3/10

(52) U.S. Cl. 372/26

(57) ABSTRACT

An apparatus and method for high speed phase modulation of optical beam. For one embodiment, an apparatus includes an optical waveguide having adjoining first and second regions disposed in semiconductor material. The first and second regions have opposite first and second doping types, respectively. First, second and third higher doped regions of semiconductor material outside an optical path of the optical waveguide are also included. The first higher doped region has the first doping type and the second and third higher doped regions have the second doping type. The first, second and third higher doped regions have higher doping concentrations than doping concentrations within the optical path of the optical waveguide. The second and third higher doped regions are symmetrically adjoining and coupled to respective opposite lateral sides of the second region. The first higher doped region is asymmetrically adjoining and coupled to only one of two opposite lateral sides of the first region. First, second and third coplanar contacts are also included and are coupled to the first, second and third higher doped regions, respectively.

### BACKGROUND OF THE INVENTION

1. Field of the Invention

The present invention relates generally to optics and, more specifically, the present invention relates to modulating optical beams.

2. Background Information

The need for fast and efficient optical-based technologies is increasing as Internet data traffic growth rate is overtaking voice traffic pushing the need for optical communications. Transmission of multiple optical channels over the same fiber in the dense wavelength-division multiplexing (DWDM) systems and Gigabit (GB) Ethernet systems provide a simple way to use the unprecedented capacity (signal bandwidth) offered by fiber optics. Commonly used optical components in the system include wavelength division multiplexed (WDM) transmitters and receivers, optical filter such as diffraction gratings, thin-film filters, fiber Bragg gratings, arrayed-waveguide gratings, optical add/drop multiplexers, lasers and optical switches. Optical switches may be used to modulate optical beams. Two commonly found types of optical switches are mechanical switching devices and electro-optic switching devices.

Mechanical switching devices generally involve physical components that are placed in the optical paths between optical fibers. These components are moved to cause switching action. Micro-electronic mechanical systems (MEMS) have recently been used for miniature mechanical switches. MEMS are popular because they are silicon based and are processed using somewhat conventional silicon processing technologies. However, since MEMS technology generally relies upon the actual mechanical movement of physical parts or components, MEMS are generally limited to slower speed optical applications, such as for example applications having response times on the order of milliseconds.

In electro-optic switching devices, voltages are applied to selected parts of a device to create electric fields within the device. The electric fields change the optical properties of selected materials within the device and the electro-optic effect results in switching action. Electro-optic devices typically utilize electro-optical materials that combine optical transparency with voltage-variable optical behavior. One typical type of single crystal electro-optical material used in electro-optic switching devices is lithium niobate (LiNbO₃).

Lithium niobate is a transparent material in the near infrared range that exhibits electro-optic properties such as the Pockels effect. The Pockels effect is the optical phenomenon in which the refractive index of a medium, such as lithium niobate, varies with an applied electric field. The varied refractive index of the lithium niobate may be used to provide switching. The applied electrical field is provided to present day electro-optical switches by external control circuitry.

Although the switching speeds of these types of devices are very fast, for example on the order of nanoseconds, one disadvantage with present day electro-optic switching devices is that these devices generally require relatively high voltages in order to switch optical beams. Consequently, the external circuits utilized to control present day electro-optical switches are usually specially fabricated to generate the high voltages and suffer from large amounts of power consumption. In addition, integration of these external high voltage control circuits with present day electro-optical switches is becoming an increasingly challenging task as device dimensions continue to scale down and circuit densities continue to increase.

### BRIEF DESCRIPTION OF THE DRAWINGS

The present invention is illustrated by way of example and not limitation in the accompanying figures.

FIG. 1A is a cross-section illustration for one example of an optical device including an optical waveguide with a single sided coplanar contact optical phase modulator with a depletion region at a pn junction interface accordance with the teachings of the present invention.

FIG. 1B is a cross-section illustration for one example of an optical device including an optical waveguide with a single sided coplanar contact optical phase modulator with an increased depletion region at a pn junction interface in accordance with the teachings of the present invention.

FIG. 2 is a diagram illustrating an example of RF attenuation and refractive index of traveling wave electrodes for an example modulator in accordance with the teachings of the present invention.

FIG. 3 is a diagram illustrating an example of RF characteristic impedance Z₀ of traveling wave electrodes for an example modulator in accordance with the teachings of the present invention.

FIG. 4 is a diagram illustrating an example of frequency response of an example modulator with RF attenuation and optical electrical index mismatching in accordance with the teachings of the present invention.

FIG. 5 is a diagram illustrating an example optical device to modulate an optical beam including an example optical phase modulator in accordance with the teachings of the present invention.

FIG. 6 is a diagram illustrating a system including an array of optical modulators with example optical phase modulators to modulate optical beams in accordance with the teachings of the present invention.

### DETAILED DESCRIPTION

Methods and apparatuses for high speed phase shifting an optical beam with an optical device are disclosed. In the following description numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments. In addition, it is appreciated that the figures provided herewith are for explanation purposes to persons ordinarily skilled in the art and that the drawings are not necessarily drawn to scale.

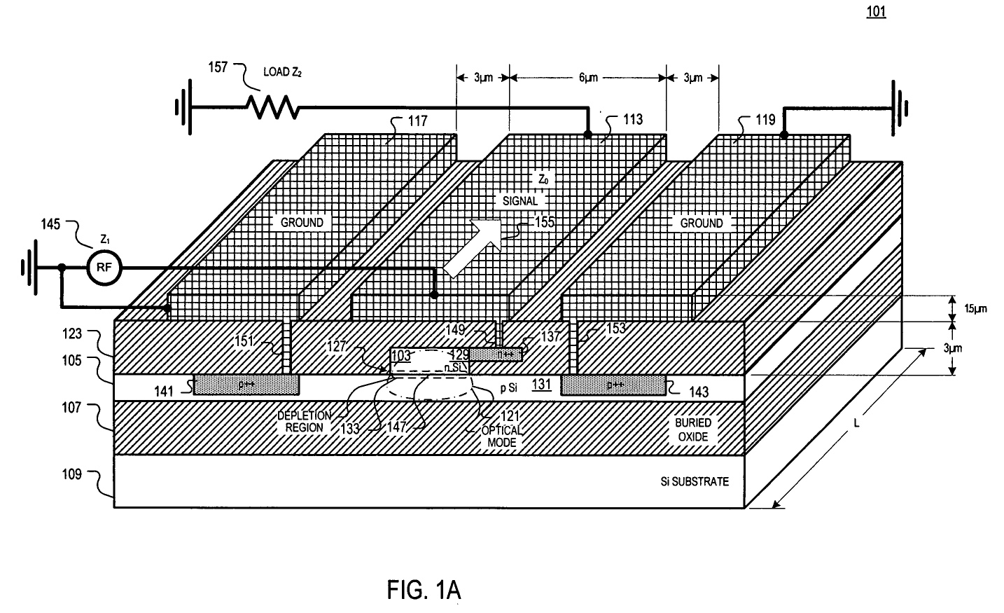

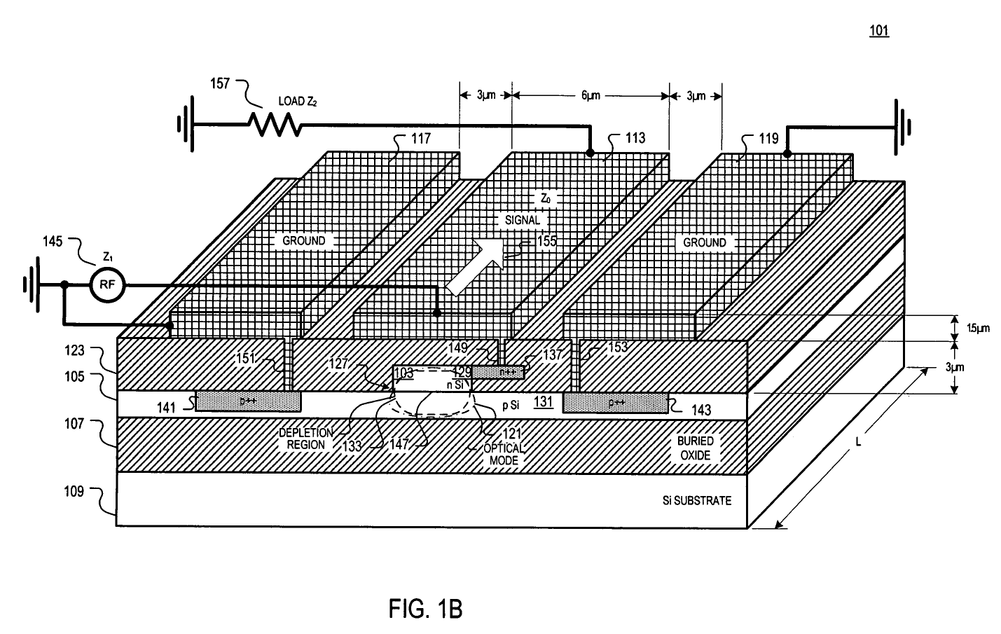

To illustrate, FIG. 1A is a cross-section diagram illustrating generally an optical device 101 including an optical waveguide 127 with a depletion region 133 at a pn junction interface 147 when there is a substantially zero external drive voltage in traveling signal 155 applied by radio frequency (RF) source 145 in accordance with the teachings of the present invention. For one example, there are substantially no free charge carriers in depletion region 133, while there are free charge carriers outside of depletion region 133 due to the n-type and p-type doping. As shown in the illustrated example, optical device 101 includes an optical waveguide 127 including adjoining regions 103 and 105 of semiconductor material having opposite doping types. In the illustrated example, optical waveguide 127 is shown as a rib waveguide including a rib region 129 and a slab region 131. As can be seen in the illustrated example, the intensity of a propagating optical mode 121 of an optical beam through optical waveguide 127 is vanishingly small at the “upper corners” of rib region 129 as well as the “sides” of the slab region 131 of optical waveguide 127. In the illustrated example, the optical beam is shown propagating “into the page” through optical waveguide 127. In other examples, it is appreciated that other types of suitable waveguides may be employed such as strip waveguides or the like. In one example, the semiconductor material includes silicon (Si). For example, region 103 may include n type silicon and region 105 may include p type silicon such that the free charge carriers in the n type silicon outside of depletion region 133 are electrons and the free charge carriers in the p type silicon outside of depletion region 133 are holes. In other examples, the semiconductor material may include other suitable types of semiconductor material such as for example germanium (Ge), Si/Ge, or the like. In one example, regions 103 and 105 in one example have doping concentrations such that the pn junction interface 147 between regions 103 and 105 is reverse biased due to the built-in electrical field. In another example, the polarities of the dopings of regions 103 and 105 may be reversed in accordance with the teachings of the present invention.

Continuing with the example illustrated in FIG. 1A, optical device 101 is included in a silicon-on-insulator (SOI) wafer, and therefore includes a buried oxide layer 107 disposed between another semiconductor layer 109 and the semiconductor material of region 105. As shown, optical device 101 also includes a buffer layer insulating material 123 which also serves as cladding material for the optical waveguide 127. In the illustrated example, optical device 101 further includes higher doped regions 137, 141 and 143, which are disposed outside the optical path of the optical mode 121 through optical waveguide 127. With higher doped regions 137, 141 and 143 disposed outside the optical path of the optical mode 123 through optical waveguide 121, optical loss is reduced. In the illustrated example, higher doped region 137 is n++doped, which is the same type of doping type as region 103 and higher doped regions 141 are p++doped, which is the same doping type (p) as region 105. In the illustrated example, higher doped regions 137, 141 and 143 have higher doping concentrations than the doping concentrations of regions 103 and 105 within the optical path of the optical mode 121 along optical waveguide 127.

As shown, higher doped regions 141 and 143 are symmetrically adjoining and coupled to respective opposite lateral sides of region 105. In contrast, higher doped region is asymmetrically adjoining and coupled to only one of the two opposite lateral sides of region 103, in accordance with the teachings of the present invention. Optical device 101 also includes coplanar contacts 113, 117 and 119, which are coupled to higher doped regions 137, 141 and 143, respectively, through the buffer layer insulating material 123 through vias 149, 151 and 153, respectively. As shown, coplanar contacts 113, 117 and 119 are also located outside the optical path of the optical mode 121 through optical waveguide 127. For one example, coplanar contacts 113, 117 and 119 include metal with high electrical conductivity and low resistance. In the illustrated example, coplanar contacts 113, 117 and 119 are combined and connected with a metal electrode designed for high frequency traveling wave signal transmission in accordance with the teachings of the present invention.

As shown the illustrated example, one end of coplanar contact 113 is coupled to receive the traveling wave signal 155 from RF source 145. The other end of coplanar contact 113 is terminated with a load impedance or termination load 157 coupled to a reference voltage such as ground. In addition, coplanar contacts 117 and 119 are coupled to the reference voltage such as ground. Thus, the bias of the pn junction interface 147 between regions 103 and 105 is adjusted with the application of the external drive voltage through traveling wave signal 155 through higher doped regions 137, 141 and 143 in accordance with the teachings of the present invention. The higher doping concentrations higher doped regions 137, 141 and 143 help improve the electrical coupling of coplanar contacts 113, 117 and 119 to semiconductor material regions 103 and 105 in accordance with the teachings of the present invention. This improved electrical coupling reduces the contact resistance between metal contacts 113, 117 and 119 and semiconductor material regions 103 and 105, which reduces the RF attenuation of the traveling wave signal 155, which improves the electrical performance of optical device 101 in accordance with the teachings of the present invention. The reduced RF attenuation and good optical electrical wave velocity matching enable faster switching times and device speed for optical device 101 in accordance with the teachings of the present invention.

In the illustrate example, the traveling wave signal 155 is applied to one end of coplanar contact 113 by RF source 145 to adjust the size or thickness of depletion region 133 at the pn junction interface 147 between regions 103 and 105 of optical waveguide 127 in accordance with the teachings of the present invention. As shown, the depletion region 133 overlaps with the optical mode 121 of the optical beam propagating through the optical waveguide 127. In the example device shown in FIG. 1, both the optical wave and RF microwaves co-propagate along the waveguide. When the RF phase velocity matches the optical group velocity, the optical beam experiences phase shift responding to the applied electrical field. The device speed is therefore not limited by the RC time constant in accordance with the teachings of the present invention.

For one example, the respective widths, heights, and relative positions to the higher doped regions 137, 141 and 143 coupled to coplanar contacts 113, 117 and 119 are designed to obtain the velocity matching. For example, RF phase velocity is generally determined by the device inductance and capacitance. By varying the metal contact geometry and semiconductor as well as dielectric layer thickness, the inductance and capacitance values can be changed, and in turn, the RF phase velocity can be matched with optical group velocity. This is called “real” phase velocity matching. In another example the phase velocities may be “artificially” matched by, for example, utilizing a phase reversed electrode design. In addition, doping distribution and metal electrode may be designed to obtain a small RF attenuation. For instance, less than 6 dB is needed for the benefit using traveling wave drive scheme in accordance with the teachings of the present invention.

For one example, when there is no external drive voltage or when the external drive voltage from traveling wave signal 155 is substantially zero, the depletion region 133 at the pn junction interface 147 between regions 103 and 105 of optical waveguide 127 is a result of the built-in electrical field caused by the doping concentrations of regions 103 and 105. However, when a non-zero external drive voltage is applied via traveling wave signal 155, the reverse bias at the pn junction interface 147 between regions 103 and 105 of optical waveguide 127 is increased, which results in the corresponding depletion region 133 being substantially larger or thicker in accordance with the teachings of the present invention.

To illustrate, FIG. 1B provides an illustration showing for example a non-zero external drive voltage being applied via the traveling wave signal 155, which results in the increased reverse bias at the pn junction interface 147 between regions 103 and 105 of optical waveguide 127. As can be observed, the corresponding depletion region 133 is substantially larger or thicker with non-zero external drive voltage in accordance with the teachings of the present invention. As a result of the larger or thicker depletion region 133, a greater cross-sectional area of the mode of optical beam 121 propagating along the optical path through optical waveguide 127 overlaps with and propagates through a depletion region with substantially no free charge carriers, when compared to the smaller or thinner depletion region 133 illustrated in FIG. 1A with a substantially zero external drive voltage applied via the traveling wave signal 155

By modulating depletion region 133 at the pn junction interface 147 between regions 103 and 105 of optical waveguide 127 in response drive signal 145 as shown, the overall concentration of free charge carriers along the optical path of optical waveguide 127 through which the optical beam 121 is directed is modulated in response to the external drive voltage applied via the traveling wave signal 155 by modulating the size of the depletion region 133 in accordance with the teachings of the present invention. As will be discussed, the phase of the optical beam 121 propagating along the optical path through optical waveguide 127 is therefore modulated in response to traveling wave signal 155 in accordance with the teachings of the present invention.

In operation, the optical beam is directed through optical waveguide 127 along an optical path through depletion region 133. Traveling wave signal 155 is applied to optical waveguide 127 through coplanar contact 113 to modulate or adjust the thickness of depletion region 133, which modulates the presence or absence of free charge carriers along the optical path through optical waveguide 127. Stated differently, the overall free charge carrier concentration along the optical path of optical waveguide 127 is modulated in response to the traveling wave signal 155 applied to optical waveguide 127 through coplanar contact 113. The free charge carriers present or absent along the optical path through which the optical beam is directed through optical waveguide 127 may include for example electrons, holes or a combination thereof. The presence of free charge carriers may attenuate optical beam when passing through. In particular, the free charge carriers along the optical path of optical waveguide 127 may attenuate optical beam by converting some of the energy of optical beam into free charge carrier energy. Accordingly, the absence or presence of free charge carriers in the depletion region 133 in response to traveling wave signal 155 will modulate optical beam in accordance with the teachings of the present invention.

In the illustrated example, the phase of optical beam that passes through depletion region 133 is modulated in response to the traveling wave signal. For one example, the phase of optical beam passing through free charge carriers or the absence of free charge carriers in optical waveguide 127 is modulated due to the plasma dispersion effect. The plasma dispersion effect arises due to an interaction between the optical electric field vector and free charge carriers that may be present along the optical path of the optical beam in optical waveguide 127. The electric field of the optical beam polarizes the free charge carriers and this effectively perturbs the local dielectric constant of the medium. This in turn leads to a perturbation of the propagation velocity of the optical wave and hence the index of refraction for the light, since the index of refraction is simply the ratio of the speed of the light in vacuum to that in the medium. Therefore, the index of refraction in optical waveguide 127 of optical device 101 is modulated in response to the modulation of free charge carriers. The modulated index of refraction in the optical waveguide 127 of optical device 101 correspondingly modulates the phase of optical beam propagating through optical waveguide 127 of optical device 101. In addition, the free charge carriers are accelerated by the field and lead to absorption of the optical field as optical energy is used up. Generally the refractive index perturbation is a complex number with the real part being that part which causes the velocity change and the imaginary part being related to the free charge carrier absorption. The amount of phase shift φ is given by

φ=(2π/λ)ΔnL (Equation 1)

with the optical wavelength λ, the refractive index change Δn and the interaction length L. In the case of the plasma dispersion effect in silicon, the refractive index change Δn due to the electron (ΔNₑ) and hole (ΔNₕ) concentration change is given by:

$$Δ n = - \frac{{e}^{2} {λ}^{2}}{8 {π}^{2} {c}^{2} {ɛ}_{0} {n}_{0}} ( \frac{{{b}_{e} ( Δ {N}_{e} )}^{1.05}}{{m}_{e}^{*}} + \frac{{{b}_{h} ( Δ {N}_{h} )}^{0.8}}{{m}_{h}^{*}} ) \qquad ( Equation 2 )$$

where nₒ is the refractive index of intrinsic silicon, e is the electronic charge, c is the speed of light, ∈₀ is the permittivity of free space, mₑ* and mₕ* are the electron and hole effective masses, respectively, bₑ and bₕ are fitting parameters. The optical absorption coefficient change Δα due to free charge carriers in silicon are given by

$$Δ α = \frac{{e}^{3} {λ}^{2}}{4 {π}^{2} {c}^{3} {ɛ}_{0} {n}_{0}} [ \frac{Δ {N}_{e}}{{m}_{e}^{* 2} {μ}_{e}} + \frac{Δ {N}_{h}}{{m}_{h}^{* 2} {μ}_{h}} ] \qquad ( Equation 3 )$$

where μₑ is the electron mobility and μₕ is the hole mobility.

In one example, the size of optical waveguide 127 is relatively small with dimensions such as 0.5 μm×0.5 μm to enable better optical phase modulation efficiency. As summarized above, higher doped region 137 is asymmetrically adjoining and coupled to region 103 as only one of the two lateral sides of region 103 is coupled to a higher doped region. In contrast, both lateral sides of region 105 are adjoining and coupled to higher doped regions 141 and 143. Because of this single sided contact to region 103 has a much lower capacitance than a symmetric double sided contact and also helps to achieve the required phase matching between electrical and optical signals, smaller RF attenuation, and larger (closer to 25 or 50 Ohms in one example) characteristic impedance for better driver-transmission line power coupling in accordance with the teachings of the present invention.

The traveling wave driving scheme employed in accordance with the teachings of the present invention helps to overcome RC time constant capacitance limits of optical device 101 to realize faster modulation speeds of 40 GHz and beyond with rise/fall times of approximately 5 ps or less of the reverse biased pn junction modulator. With the traveling-wave driving scheme employed by optical device 101, both optical and microwave signals co-propagate along the waveguide 127. If optical group velocity matches the RF phase velocity, RF attenuation will determine the true speed of optical device 101 instead of the RC time constant of optical device 101. Because the RF characteristics of a traveling wave electrode such as coplanar contact 113 strongly depends on both the pn junction and metal pattern, careful device design is employed in accordance with the teachings of the present invention. In addition, the impedance of the traveling-wave electrode, coplanar contact 113, is optimized in one example to match the RF driver impedance of RF source 145 for better microwave power coupling in accordance with the teachings of the present invention.

As shown in the depicted example, coplanar contact 113 functions as a traveling wave electrode for optical device 101 with a transmission line impedance of Z₀. RF source 145 has a load impedance of Z₁ and termination load 157 has a load impedance of Z₂. In one example, the load impedance of Z1 is approximately 25-50 Ohms, which results in a low RC time constant for optical device 101 combined with small RF attenuation enabling fast switching speeds and high speed operation in accordance with the teachings of the present invention. Coplanar contact 113 is a combined coplanar waveguide and microstrip because of the reverse biased pn junction interface 147. As illustrated, coplanar contact 113 is disposed between coplanar contacts 117 and 119 on top of pn junction interface 147 and optical waveguide 127 with a via 149 coupled to the n++ higher doped region 137 to deliver traveling wave signal 155 to optical waveguide 127. Coplanar contacts 117 and 119 function as two side metal plates for grounding. In one example, coplanar contact 113 is approximately 6 μm wide. The gap between coplanar contact 113 and the side coplanar contacts 117 and 119 is approximately 3 μm. The thickness of coplanar contacts 113, 117 and 119 is approximately 1.5 μm. The height of the vias 149, 151 and 153 through the insulating material 123 is approximately 3 μm.

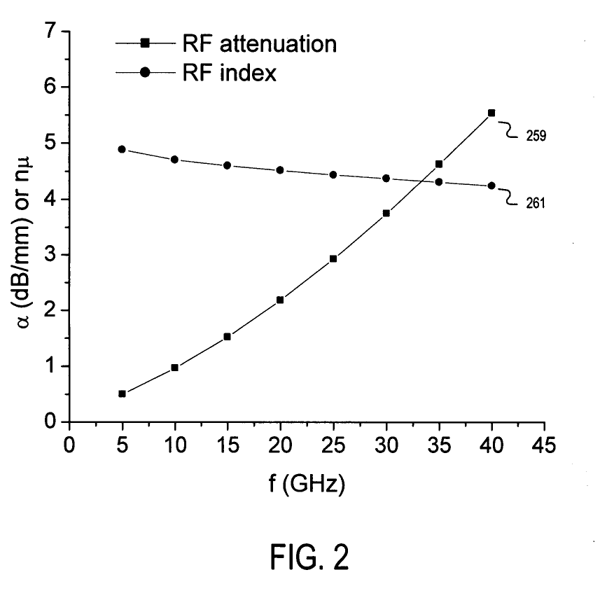

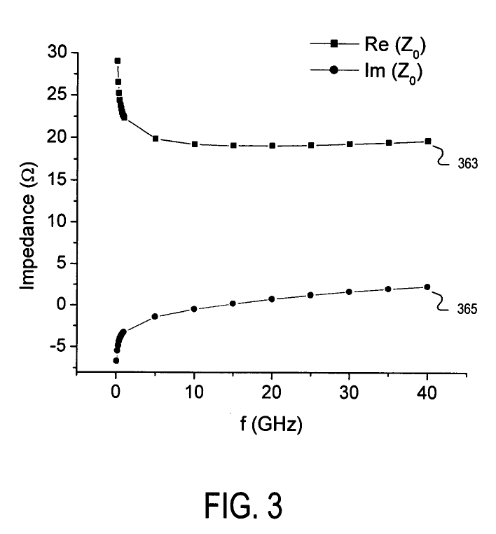

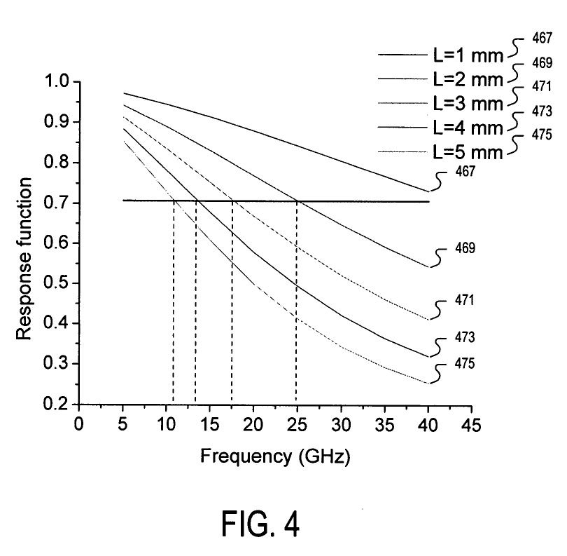

FIG. 2 shows the modeled the RF attenuation 259 (in dB/mm) and refractive index 261 vs. frequency in GHz for one example optical device 101. FIG. 3 shows the modeled RF real and imaginary parts of the characteristic impedance Z₀ 363 and 365 in Ohms of the traveling-wave electrodes vs. frequency in GHz of an example of optical device 101. It is noted that the optical group index of example optical waveguide 127 is approximately 3.7. Using the modeled results illustrated in FIGS. 2 and 3, the calculated the modulator frequency response functions of an optical modulator, taking into account both RF attenuation and optical-electrical signal walk-off effects or mismatching, are shown in FIG. 4 with a variety of example interaction lengths L=1 mm 467, L=2 mm 469, L=3 mm 471, L=4 mm 473 and L=5 mm 475 in accordance with the teachings of the present invention. As can be seen, the speed of an example modulator utilizing an example of optical device 101 is >10 GHz for an L=5 mm 475 long modulator, >17 GHz for 3 mm 471 modulator, and >40 GHz for 1 mm 467 modulator in accordance with the teachings of the present invention. With a slight modification of the pn junction design, >28 GHz (or 40 Gb/s) speed can be achieved for 2.5 mm long phase shifter, which leads to π phase shift in push-pull operation. Therefore, an example silicon modulator employing optical device 101 with a single sided contact traveling-wave electrode can indeed operate in speed of 40 Gb/s in accordance with the teachings of the present invention.

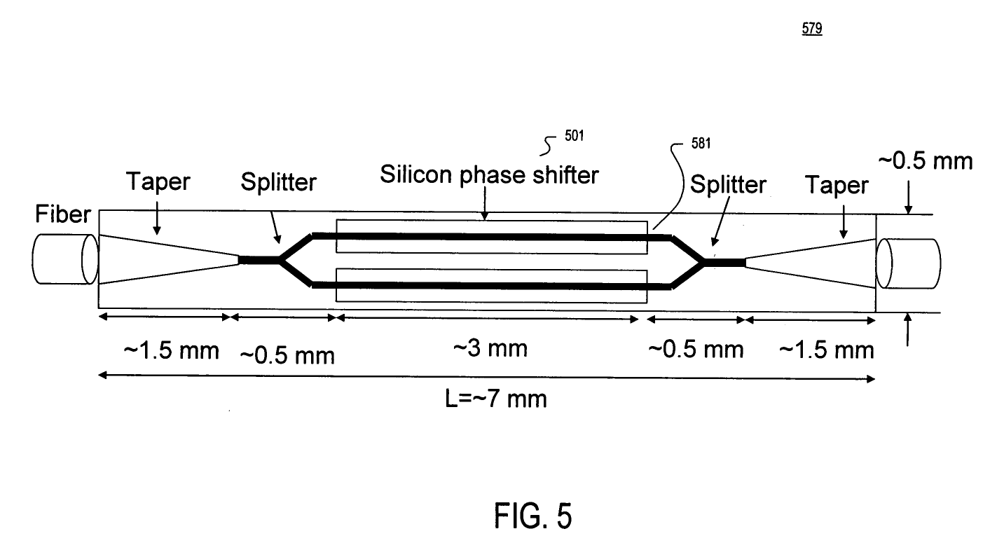

FIG. 5 shows an example optical modulator 579 employing an example silicon phase shifter 501 in accordance with the teachings of the present invention. In the illustrated example, silicon phase shifter 501 of FIG. 5 shares similarities with example optical device 101 of FIGS. 1A and 1B. In the example illustrated in FIG. 5, optical modulator 579 includes a Mach-Zehnder Interferometer (MZI) 581 with at least one of the arms of the MZI 581 including a silicon phase shifter 501. In one example, an optical beam is directed into the MZI 581 of optical modulator 579 through an optical fiber and a taper. The optical beam is split and a phase difference between the arms of the MZI 581 can be modulated with silicon phase shifter 501 to modulate the optical beam as it is output from the MZI and exits the optical modulator 579 through another taper into another optical fiber in accordance with the teachings of the present invention. In the illustrated example, the taper lengths in the optical modulator 579 have a length of approximately 1.5 mm, the lengths of the splitter portions of the MZI 581 have lengths of approximately 0.5 mm and the lengths of the arms of the MZI 581 have lengths of approximately 3 mm, which result in a total length of the example optical modulator 579 approximately 7 mm. As shown, the width of the example optical modulator 579 is approximately 0.5 mm. Accordingly, the RF mode in optical modulator 579 is so tightly confined with the small dimensions and coplanar contacts as described that there is no significant electromagnetic interference for the small waveguide separation in the MZI 581. This enables the smaller size of optical modulator 579 and therefore more optical modulators 579 can be fabricated on a single die, and as a result, increase the transmission capacity of a single fiber by using wave division multiplexing WDM in accordance with the teachings of the present invention.

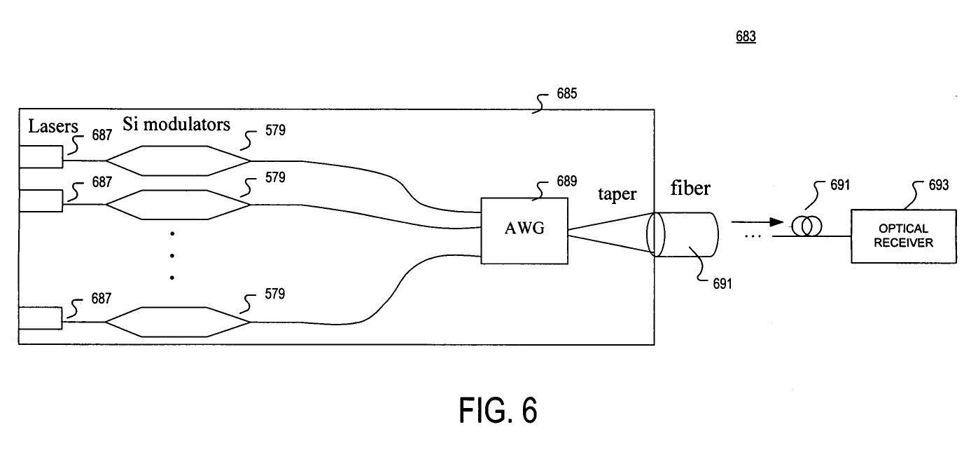

To illustrate, FIG. 6 is an illustration of an example optical system 683 including a plurality or array of such optical modulators 579 disposed in a single die 685 in accordance with the teachings of the present invention. As shown, optical system 683 includes a one or more of optical sources 687, each of which generates an optical beam coupled to be received by a respective one or more optical modulator 579. In the illustrated example, the optical sources 687 are illustrated as lasers disposed in the single die 685. In the illustrated example, each of the optical modulators 579 is similar to the example optical modulators shown in FIG. 5 or FIGS. 1A and 1B. In the illustrated example, the modulated optical beams output from each respective one of the optical modulators 579 are received by an N×1 optical coupler 689. In the illustrated example, the N×1 optical coupler 689 is an array waveguide grating (AWG) disposed in the single die 685. In the illustrated example, the output of the optical coupler 689 is a WDM optical signal and is output from the single die 685 through a taper into an optical fiber 691 and is coupled to be received by an optical receiver 693 in accordance with the teachings of the present invention.

In the foregoing detailed description, the method and apparatus of the present invention have been described with reference to specific exemplary embodiments thereof. It will, however, be evident that various modifications and changes may be made thereto without departing from the broader spirit and scope of the present invention. The present specification and figures are accordingly to be regarded as illustrative rather than restrictive.

What is claimed is:

1. An apparatus, comprising:
an optical waveguide having adjoining first and second regions disposed in semiconductor material, the first and second regions having opposite first and second doping types, respectively;
first, second and third higher doped regions of semiconductor material outside an optical path of the optical waveguide, the first higher doped region having the first doping type and the second and third higher doped regions having the second doping type, the first, second and third higher doped regions having higher doping concentrations than doping concentrations within the optical path of the optical waveguide, the second and third higher doped regions symmetrically adjoining and coupled to respective opposite lateral sides of the second region, the first higher doped region asymmetrically adjoining and coupled to only one of two opposite lateral sides of the first region; and
first, second and third coplanar contacts coupled to the first, second and third higher doped regions, respectively.

2. The apparatus of claim 1 further comprising a depletion region overlapped by the optical path of the optical waveguide at an interface between the first and second regions of the waveguide, the first and second regions of the waveguide having respective doping concentrations such that the depletion region is present without a drive voltage externally applied to the optical waveguide.

3. The apparatus of claim 2 wherein a size of the depletion region at the interface between the first and second regions of the optical waveguide is increased in response to the drive voltage externally applied to the optical waveguide.

4. The apparatus of claim 1 wherein the first contact is a traveling wave electrode such that one end of the first contact is coupled to receive a traveling wave drive signal from a radio frequency (RF) source and an other end of the first contact is coupled to a termination load.

5. The apparatus of claim 1 wherein both optical and microwave signals are coupled to co-propagate along the optical waveguide.

6. The apparatus of claim 1 wherein the coplanar first, second and third coplanar contacts are coupled to the first, second and third higher doped regions through first, second and third signal vias through insulating material.

7. The apparatus of claim 1 wherein the semiconductor material comprises silicon and the first, second and third coplanar contacts comprise metal.

8. A method, comprising:
directing an optical beam along an optical path through an optical waveguide having adjoining first and second regions disposed in semiconductor material, the first and second regions having opposite first and second doping types, respectively;
applying a traveling wave drive signal to one end of a first contact coupled to a first higher doped region, wherein an other end of the first contact is coupled to a termination load, wherein second and third contacts are coupled to a reference and to second and third higher doped regions, respectively, wherein the second and third higher doped regions symmetrically adjoining and coupled to respective opposite lateral sides of the second region, and wherein the first higher doped region asymmetrically adjoining and coupled to only one of two opposite lateral sides of the first region; and
modulating a depletion region overlapped by the optical path of the optical waveguide at an interface between the first and second regions of the waveguide.

9. The method of claim 8 further comprising modulating a phase of the optical beam in response to modulating the depletion region.

10. The method of claim 8 wherein the first higher doped region has the first doping type and the second and third higher doped regions have the second doping type.

11. The method of claim 10 wherein the first, second and third higher doped regions have higher doping concentrations than doping concentrations within the optical path of the optical waveguide.

12. The method of claim 8 wherein the first, second and third contacts are coplanar with one another.

13. The method of claim 12 further comprising coupling the first, second and third contacts to the first, second and third higher doped regions through first, second and third signal vias through insulating material.

14. A system, comprising:
an optical source to generate an optical beam;
an optical receiver optically coupled to receive the optical beam;
an optical fiber optically coupled to the optical receiver, the optical beam directed through the optical fiber to the optical receiver; and
an optical device optically coupled between the optical source and the optical receiver, the optical device including an optical phase shifter optically coupled to the optical fiber to modulate a phase of the optical beam, the optical phase shifter including:
an optical waveguide having adjoining first and second regions disposed in semiconductor material, the first and second regions having opposite first and second doping types, respectively;
first, second and third higher doped regions of semiconductor material outside an optical path of the optical waveguide, the first higher doped region having the first doping type and the second and third higher doped regions having the second doping type, the first, second and third higher doped regions having higher doping concentrations than doping concentrations within the optical path of the optical waveguide, the second and third higher doped regions symmetrically adjoining and coupled to respective opposite lateral sides of the second region, the first higher doped region asymmetrically adjoining and coupled to only one of two opposite lateral sides of the first region; and
first, second and third coplanar contacts coupled to the first, second and third higher doped regions, respectively.

15. The system of claim 14 wherein the optical phase shifter is included in an optical modulator disposed in the semiconductor material to modulate the optical beam.

16. The system of claim 15 wherein the optical source is one of a plurality of N optical sources and wherein the optical phase shifter is one of a corresponding plurality of N optical phase shifters disposed in the semiconductor material.

17. The system of claim 16 further comprising an N×1 optical element optically coupled to the plurality of N optical phase shifters.

18. The system of claim 14 wherein the first contact is a traveling wave electrode such that one end of the first contact is coupled to receive a traveling wave drive signal from a radio frequency (RF) source and an other end of the first contact is coupled to a termination load.

19. The system of claim 14 wherein the coplanar first, second and third coplanar contacts are coupled to the first, second and third higher doped regions through first, second and third signal vias through insulating material.

20. The system of claim 14 the semiconductor material comprises silicon and the first, second and third coplanar contacts comprise metal.
